(19) United States
(12) Patent Application Publication
(10) Pub. No.: US 2002/0149534 A1
(43) Pub. Date: Oct. 17, 2002

(54) Antenna shielding

(76) Inventor: Joseph A. Bobier, Cudjoe Key, FL (US)

Correspondence Address: Dennis L. Cook, Fowler White Boggs Banker, P.A., Suite 1700, 501 E. Kennedy Blvd., Tampa, FL, 33602, US

(21) Appl. No.: 10/119,496

(22) Filed: Apr. 10, 2002

Related U.S. Application Data
(60) Provisional application No. 60/283,729, filed on Apr. 12, 2001.

(51) Int. Cl. H01Q 1/52

(52) U.S. Cl. 343/841; 343/890

(57) ABSTRACT

The present invention is a set of devices that enables an installer of antennas grouped on towers or other transmitting structures to maximize efficiency of the placement of the antennas and eliminate unwanted interference from the other collocated antennas.

### RELATED APPLICATION

The present application claims the benefit of previously filed co-pending Provisional Patent Application, Serial No. 60/283,789.

### FIELD OF THE INVENTION

The present invention relates to the field of antennas used for high-speed wireless Internet access and more specifically to an improvement in devices and methods for shielding antennas.

### BACKGROUND OF THE INVENTION

As the communications industry continues to evolve, ever-increasing demand for high-speed broadband solutions for communications will result, with the accompanying technologies experiencing a similar demand pattern. While industry analysts predict that 100-megabit speeds will be common by the year 2002, the disclosed system design can assist in delivering these speeds now.

The need for high-speed Internet access within the U.S. is well defined. With respect to Internet applications alone, as of December 1999, there were fewer than 250,000 U.S. customers purchasing DSL services, as compared to more than 30 million Internet customers. The ever-increasing need for wireless communication services such as Cellular Mobile Telephone (CMT), Digital Cellular Network (DCN), Personal Communication Services (PCS) and the like, typically requires the operators of such systems to serve an ever-increasing number of users in a given service area. As a result, certain types of base station equipment including high capacity Broadband Transceiver Systems (BTS) have been developed which are intended to service a relatively large number of active mobile stations in each cell. Such Broadband Transceiver System equipment can typically service, for example, ninety-six simultaneously active mobile stations in a single four-foot tall rack of electronic equipment. This base station equipment typically costs less than $2000 to $4000 per channel to deploy, and so the cost per channel serviced is relationally low. But, demand is increasing beyond capacity and downward cost pressures continue to exist.

Numerous patents have attempted to solve these problems such as U.S. Pat. No. 5,970,410 issued to Carney, et al. on Oct. 19, 1999, titled Cellular System Plan Using In Band-Translators To Enable Efficient Deployment Of High Capacity Base Transceiver Systems that describes a wireless system architecture whereby high efficiency broadband transceiver systems can be deployed at an initial build out stage of the system in a cost-efficient manner. A home base station location is identified within each cluster of cells, and rather than deploy a complete suite of base station equipment at each of the cells in the cluster, inexpensive translator units are located in the outlying cells serviced by the home base station in which low traffic density is expected. The translators are connected to directional antennas arranged to point back to the home base station site. The translators are deployed in such a way which meshes with the eventually intended frequency reuse for the entire cluster of cells. The translator to base station radio links operate in-band, that is, within the frequencies assigned to the service provider. For example, the available frequency bands are divided into at least two sub-bands, with a first sub-band assigned for use as a home base station to translator base station communication link and a second sub-band is assigned for use by the mobile station to translator communication link. If desired, a third sub-band can then be used for deployment of base transceiver systems in the conventional fashion where the base station equipment located at the center of a cell site communicates only with mobile stations located within that cell. When coupled with efficient frequency reuse schemes, maximum efficiency in densely populated urban environments is obtained. According to some arrangements, the cells are each split into radial sectors and frequencies are assigned to the sectors in such a manner as to provide the ability to reuse available frequencies. Although frequency reuse schemes can be highly efficient, it requires at least two complete sets of multi-channel transceiver equipment such as in the form of a Broadband Transceiver System (BTS) to be located in each cell.

However, when a wireless system first comes on line, demand for use in most of the cells is relatively low, and it is typically not possible to justify the cost of deploying complex multi-channel BTS equipment based only upon the initial number of subscribers. Because only a few cells at high expected traffic demand locations (such as at a freeway intersection) will justify the expense to build-out with high capacity BTS equipment, the service provider is faced with a dilemma. The provider can build-out the system with less expensive narrowband equipment initially, to provide some level of coverage, and then upgrade to the more efficient equipment as the number of subscribers rapidly increases in the service area. However, the initial investment in narrowband equipment is then lost. Alternatively, a larger up front investment can be made to initially deploy high capacity equipment, so that once demand increases, the users of the system can be accommodated without receiving busy signals and the like. But this has the disadvantage of carrying the money cost of a larger up front investment.

Other various techniques for extending the service area of a given cell have been proposed. For example, U.S. Pat. No. 4,727,490 issued to Kawano et al. on Mar. 7, 1984, and assigned to Mitsubishi Denki Kabushiki Kaisha, discloses a mobile telephone system in which a number of repeater stations are installed at the boundary points of hexagonally shaped cells. The repeaters define a small or minor array that is, in effect, superimposed on a major array of conventional base stations installed at the center of the cells. With this arrangement, any signals received in so-called minor service areas by the repeaters are relayed to the nearest base station.

Another technique was disclosed in U.S. Pat. No. 5,152,002 issued to Leslie, et al., on Feb. 13, 1990, wherein the coverage of a cell is extended by including a number of so-called “boosters” arranged in a serial chain. As a mobile station moves along an elongated area of coverage, it is automatically picked up by an approaching booster and dropped by a receding booster. These boosters, or translators, use highly directive antennas to communicate with one another and thus ultimately via the serial chain with the controlling central site. The boosters may either be used in the mode where the boosted signal is transmitted at the same frequency as it is received or in a mode where the incoming signal is retransmitted at a different translated frequency.

Additional attempts to improve coverage include spectral efficiency schemes such as disclosed in U.S. Pat. No. 5,592,490 issued to Barratt, et al. on Jan. 7, 1997, titled Spectrally Efficient High Capacity Wireless Communication Systems which discloses a wireless system comprising a network of base stations for receiving uplink signals transmitted from a plurality of remote terminals and for transmitting downlink signals to the plurality of remote terminals using a plurality of conventional channels, including a plurality of antenna elements at each base station for receiving uplink signals, a plurality of antenna elements at each base station for transmitting downlink signals, a signal processor at each base station connected to the receiving antenna elements and to the transmitting antenna elements for determining spatial signatures and multiplexing and demultiplexing functions for each remote terminal antenna for each conventional channel, and a multiple base station network controller for optimizing network performance, whereby communication between the base stations and a plurality of remote terminals in each of the conventional channels can occur simultaneously.

Other methods include specialized propagation techniques such as shown in U.S. Pat. No. 6,058,105 issued to Hochwald, et al. on May 2, 2000, titled Multiple Antenna Communication System and Method Thereof which discloses a communications system that achieves high bit rates over an actual communications channel between M transmitter antennas of a first unit and N receiver antennas of a second unit, where M or N>1, by creating virtual sub-channels from the actual communications channel. The multiple antenna system creates the virtual sub-channels from the actual communications channel by using propagation information characterizing the actual communications channel at the first and second units. For transmissions from the first unit to the second unit, the first unit sends a virtual transmitted signal over at least a subset of the virtual sub-channels using at least a portion of the propagation information. The second unit retrieves a corresponding virtual received signal from the same set of virtual sub-channels using at least another portion of said propagation information.

Unfortunately, each of these techniques has their difficulties and add additional costs and complexities to the system. With the method that uses an array of repeaters co-located with the primary cell sites, the implementation of diversity receivers becomes a problem. Specifically, certain types of cellular communication systems, particularly those that use digital forms of modulation, are susceptible to multi-path fading and other distortion. It is imperative in such systems to deploy diversity antennas at each cell site. This repeater array scheme makes implementation of diversity antennas extremely difficult, since each repeater simply forwards its received signal to the base station, and diversity information as represented by the phase of the signal received at the repeater is thus lost.

The booster scheme works fine in a situation where the boosters are intended to be laid in a straight line along a highway, a tunnel, a narrow depression in the terrain such as a ravine or adjacent a riverbed. However, there is no teaching of how to efficiently deploy the boosters in a two-dimensional grid, or to share the available translated frequencies as must be done if the advantages of cell site extension are to be obtained throughout an entire service region, such as a large city.

The primary cause of poor cell performance is self-interference. Self-interference is caused when one radio transceiver interferes with another radio transceiver. As you add radio transceivers, the number of self-interference events per second will increase. Self-interference is caused when RF energy from one radio transceiver affects another radio transceiver. RF leaks from one radio transceiver to another by four primary means.

Antenna to antenna

Radio transceiver to radio transceiver

Coax to coax

Power supply to power supply

Antenna to antenna interference at collocated radio transmission sites is a difficult problem to solve because antennas are made to radiate and receive RF energy, and the radios are generally operating at the same, or very close frequencies. There are three principles, which must be used together, to solve the problem. The first principle is spacing. The antennas must be placed as far apart as possible. The second principle is orientation. The use of directional antennas, more specifically the use of directional antennas with a high front/back rejection ratio that will tend to cause the antenna to act like a searchlight, can supply effective orientation. Of course, it must be verified that the gain/beam width is appropriate for the area to be covered. The last principle is shielding. The previous two techniques will reduce interference by orders of magnitude, but to get rid of the interference altogether, shielding must be used.

Shielding systems for particular circuits are also well known in the prior art. For example U.S. Pat. No. 5,475,876 issued to Terada, et al. on Dec. 12, 1995, titled Tuner Unit Having Electromagnetically Isolated UHF And VHF Section With No Noise discloses a tuner unit including an antenna input filter section, a UHF section, a VHF section, and a PLL section which are electromagnetically separated by walls; an inductor for a VHF local oscillator is disposed adjacent to the UHF section, and is electromagnetically separated by a subdivision wall from the UHF section and the VHF section. Also, U.S. Pat. No. 5,671,220 issued to Tonomura on Sep. 23, 1997, titled Satellite Channel Interface In Indoor Unit Used For Satellite Data Communication discloses a Satellite Channel Interface (SCI) that is constituted by an analog section having a multiplexer unit and a down converter unit, and a digital section constituted by a modulator-demodulator unit. The Satellite Channel Interface has a single printed circuit board on which all of the above units are formed. A rectangular member surrounds the analog section, and a shield cover shields an opening portion of the rectangular member. The single printed circuit board is a multi-layered board constituted by at least three conductive layers, of which the bottom two layers are grounding electrodes. The SCI does not require the terminals and cables which are otherwise necessary, can be made compact, and can be manufactured with the reduced number of processing steps.

Also, shielding for devices has been used, such as the shielding disclosed in U.S. Pat. No. 5,564,096 issued to Hama, et al. on Oct. 8, 1996 which discloses a portable radio communication device such as a wristwatch receiver and/or transmitter that is provided with an effective noise shielding structure. The portable radio communication device includes a high frequency analog circuitry for receiving and transmitting radio signals and further includes digital circuitry for data processing and display. The noise shielding structure protects high frequency noise from being transmitted to the analog circuitry from the digital circuitry and from other outside sources. The noise shielding structure is made of electrically conductive material. In another aspect of the invention, at least one circuit board constructed of a multi-layered construction having at least one inner printed wire pattern is provided. The inner printed wire pattern is set at ground potential with respect to the high frequency output from the analog circuitry. In this manner the inner printed wire pattern serves as a noise shielding member. In addition, the invention obtains effective noise shielding without increasing the size or the manufacturing cost of the device.

A similar device shielding use is shown in U.S. Pat. No. 5,124,889 issued to Humbert, et al. on Jun. 23, 1992, titled Electromagnetic Shielding Apparatus For Cellular Telephones that discloses an electromagnetic shielding apparatus for portable telephones and other electronic equipment, including shield clips for intercoupling the conductive surfaces of a housing to the metal layer of the circuit board. Each shield clip mates with a corresponding edge of the circuit board such that tabs insert into holes in the central channel of the clip, and feet of the clip rest on other tabs. The clip is bonded to the metal layer of the circuit board preferably by resistance welding, thereby reliably connecting the clip and the conductive housing surfaces to signal ground.

Finally, U.S. Pat. No. 5,777,856 issued to Phillips, et al. on Jul. 7, 1998, titled Integrated Shielding And Mechanical Support discloses an integrated shielding and mechanical support that simultaneously addresses the problems of providing RF shielding for an electronic device such as a radio transceiver and providing a rigid mechanical assembly for the electronic device. Two conductive rails hold together multiple Printed Circuit Boards (PCBs) having conductive layers to produce a four-sided shielding box that protects certain electronic circuits on the PCBs from electromagnetic interference. An internal conductive shield subdivides the inside of the shielding box to provide additional protection for sensitive circuitry. The shielding box inserts into an opening in a five-sided housing section which simplifies assembly of PCBs in the housing and facilitates automated assembly. A second housing section attaches to the shielding box once it is inserted into the five-sided housing section.

Additional patents have been found that disclose shielding devices specifically for antennas such as U.S. Pat. No. 6,025,804 issued to Davis, et al. on Feb. 15, 2000, titled Antenna With Absorptive Radiation Shield that discloses an antenna including a radiating element covered with a protective jacket having at least one pocket selectively located therein. At least one pocket is filled with a material having an absorptive index substantially higher than the index of the protective jacket. This material imposes substantial restriction to the free radiation of radio frequency energy. Conversely, the remainder of the jacket with no pockets provides for the unrestricted radiation of the radio frequency energy therethrough. As a result, the antenna directionally radiates energy without the use of reflectors or additional radiating elements. This patent solves a problem associated with handheld devices using quarter wave antennas. Also, U.S. Pat. No. 6,095,820 issued to Luxon, et al. on Aug. 1, 2000, titled Radiation Shielding and Range Extending Antenna Assembly discloses an antenna assembly for transmitting a radio signal from a radio signal transmitting device including an antenna unit comprised of a dipole driven antenna member for transmitting a radio signal from the radio signal transmitting device. A radiation reflector reflects the radio signal transmitted by the driven antenna member, and a support member supports the driven antenna member and the radiation reflector so that a predetermined gap is precisely maintained between the driven antenna member and the radiation reflector. A shielding member shields a portion of the radio signal transmitted by the driven antenna member in a direction toward the shielding member. The antenna unit is pivotally mounted so that it is disposable at selectable positions relative to the shielding member. The output of the radio signal transmitted by the driven antenna member can be controlled depending on a position of the antenna unit. The dipole driven antenna member comprises a first and a second segment made from a metal foil. To reduce the overall length of the antenna, each segment has an unfolded portion and a folded portion. The radiation reflector is a metal wire, also having an unfolded portion and folded portions. This construction makes the inventive antenna assembly compact, while being effective both as a transmitting and receiving unit. The radiation reflector directs a portion of the radio signal toward the open transmission area, so as to extend a transmission range of the antenna assembly, and thus extend the transmission range of the radio signal transmitting device. By this construction, at least some of the radiation signal that is emitted from the driven antenna member in directions toward the user is blocked by the shielding member. Thus, the inventive antenna assembly has a compact construction, preventing unwanted exposure of the user to potentially harmful radiation, and providing an enhanced and extended transmission signal to enable improved communication. The Luxon, et al. patent also serves to provide a shield for cell phones or other portable devices to direct some of the energy away from the users head. The invention disclosed in this patent application is used to isolate, to a very high degree, the antenna of one transceiver from the antenna of another transceiver, while both are operating on the same frequency.

Finally U.S. Pat. No. 5,298,906 issued to Lantagne, et al. on Mar. 29, 1994, titled Antenna Isolation For Continuous Wave Radar Systems discloses a radio frequency energy radar system having a transmitting antenna system for transmitting and directing CW radio frequency energy toward a target. A receiving antenna system, adjacent to the transmitting antenna system, receives portions of the transmitted CW radio frequency energy reflected by the target. The receiving antenna system, including a plurality of antenna elements disposed along a path, and arranged to provide an antenna pattern, having a main lobe antenna pattern directed toward the target and adjacent side lobe antenna pattern. A septum is positioned between the transmitting antenna and the receiving antenna, for shielding unwanted portions of the transmitted CW radio frequency energy from passing directly from the transmitting antenna to the antenna elements of the receiving antenna. The shielding means terminates along an edge positioned in a region forward of the antenna elements. The distances between the antenna elements and points along the edge are selected to produce a non-uniform phase distribution of unwanted CW energy scattered by the edge and received by the antenna elements, such phase distribution being selected to enable the receiving antenna system to focus such unwanted scattered energy into the side lobe antenna pattern, thereby decreasing the amount of coupled energy from the transmit array to the receive array. The Lantagne, et al. patent uses destructive interference patterns, derived by directing out-of-phase carrier waves to the receiving antenna, to create a shielding effect. This complicated approach is not practical in the high deployment, cost conscious environment of high-speed wireless systems. The disclosed invention of this application works more like a Faraday cage to simply block all radio frequency from reaching the antenna from non-desired direction. This is a cost effective and simple solution, and one that is needed in the art of high-speed wireless systems.

None of the above patents disclose an effective shielding system allowing for collocation of multiple antennas. Therefore, a need exists for an antenna shielding system for a wireless communications system which achieves high bit rates in a cost effective and relatively simple manner.

It is therefore clear that a primary object of this invention is to advance the art of high-speed wireless Internet access system design. A more specific object is to advance said art by providing an improved antenna shielding design for radio deployment systems useful for high-speed wireless Internet access.

These and other important objects, features, and advantages of the invention will become apparent as this description proceeds. The invention accordingly comprises the features of construction, combination of elements and arrangement of parts that will be exemplified in the construction hereinafter set forth, and the scope of the invention will be indicated in the claims.

As the above background reveals, there is a need for an antenna shielding device and method, that is convenient and easy to use, that enables an installer of antennas grouped on towers or other transmitting structures to maximize efficiency of the placement and eliminate unwanted interference from the other collocated antennas.

Therefore, it is an object of this invention to supply a simple device that greatly increases the number of antennas that can be placed close together without unwanted interference.

### SUMMARY OF THE INVENTION

The present invention is a set of shielding devices that enables an installer of antennas grouped on towers or other transmitting structures to maximize efficiency of the placement and eliminate unwanted interference from the other collocated antennas.

### BRIEF DESCRIPTION OF THE DRAWINGS

Other objects, features, and advantages of the present invention will become apparent from the detailed description of the invention, which follows, when considered in light of the accompanying drawings in which:

FIG. 1 is a front view of an embodiment of the device for antennas facing in opposing directions;

FIG. 2 is a front view of an embodiment of the device for antennas mounted side by side;

FIG. 3 is a front view of an embodiment of the device for multiple antennas mounted in a circular manner;

FIG. 4 is a front view of an alternative embodiment of the device for multiple antenna use; and

FIG. 5 is a front view of another alternative embodiment of the device with box shielding.

### DESCRIPTION OF THE PREFERRED EMBODIMENT

The present invention will now be described more fully, hereinafter, with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Antenna to antenna interference at collocated radio transmission sites is a difficult problem to solve because antennas are made to radiate and receive RF energy and the collocated radios are generally operating at the same, or very close frequencies. This problem can be particularly difficult when mounting the system on buildings, towers, smoke stacks, bridges, water tanks, or some other structure. There are three basic methods, which must be used together, to solve the interference problem. The first method is spacing. The antennas must be placed as far apart as possible. The second method is orientation. The use of directional antennas, more specifically the use of directional antennas with a high front/back rejection ratio that will tend to cause the antenna to act like a searchlight, can supply effective orientation. Of course, it must be verified that the gain/beam width is appropriate for the area to be covered. The last method is shielding. The previous two techniques will reduce interference by orders of magnitude, but to get rid of the interference altogether, shielding must be used.

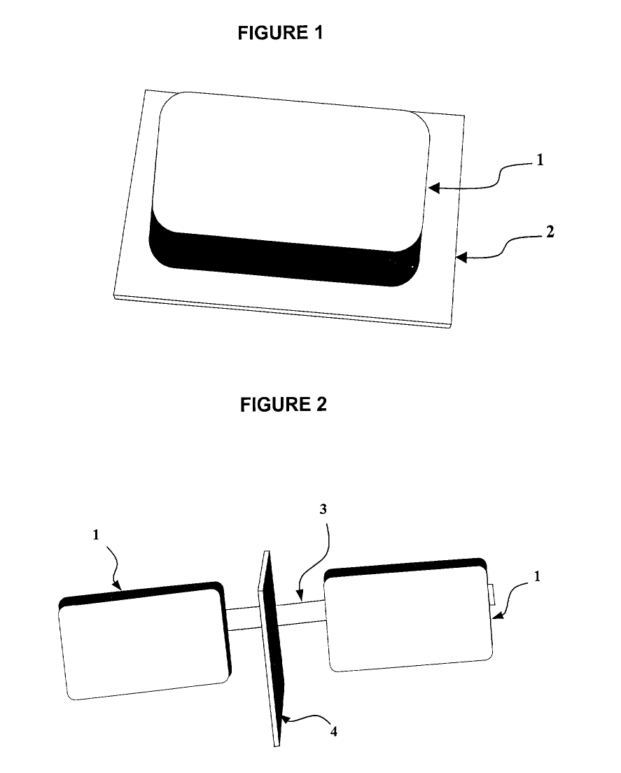

The basic rules for the shield designs disclosed in the preferred embodiments of FIGS. 1 through 5 are that the shield should be made of mild steel. The steel can be painted or galvanized for rust prevention. The shield should not be closer than 5 inches to the antenna sides. The shield works like a blinder. It must therefore be large enough to block the signal from side to side and, depending upon the antenna placement, from the rear. The shield should extend forward past the antenna by approximately 4 inches.

FIG. 1 discloses the basic shielding device that can be used when two antennas are faced in opposing directions. This shielding device, and the others disclosed in drawings 1 through 5, are shown deployed with the Breezecom uni-13 antenna but can be easily modified to be used with other antennas used in wireless systems that are well known to those skilled in the art. The shield (2) is constructed of 0.40 mild sheet steel and is mounted on the back of the antenna (1). If the antennas are facing in opposite directions, a sheet of steel creating the shield (2) as shown in FIG. 1 will provide near total isolation. The shield (2) should be drilled to match the four mounting screw holes (not shown) on the plastic back of the Breezecom uni-13 antenna (1), then the shield (2) should be sandwiched between the antenna (1) and the mounting bracket (not shown). This makes a very simple, yet effective shield.

FIG. 2 discloses an expansion to the basic concept when mounting several antennas in a horizontal manner. The adjacent shielding device, as shown, can be used to provide isolation between several antennas. This is accomplished in the preferred embodiment by welding a u-bolt (not shown) to a 0.40 mild steel sheet making the shield (4) and simply bolting the shield (4) to the horizontal pipe (3) placed between the two antennas (1).

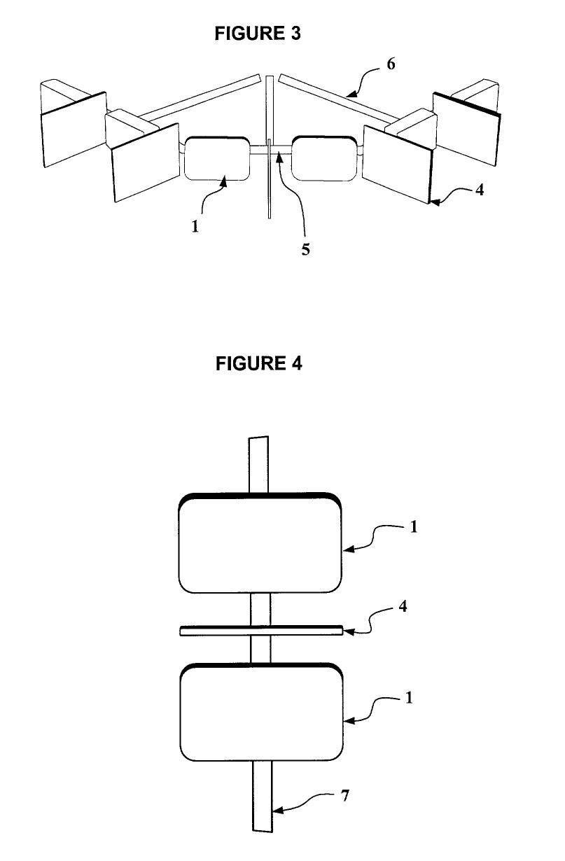

An alternative embodiment of this concept is to mount several antennas in a curved horizontal manner. The use of an alternative embodiment adjacent shielding device is shown in FIG. 3 and is constructed by again welding a u-bolt (not shown) to a 0.40 mild steel sheet making the shield (4) and simply bolting the shield (4) to a bent horizontal pipe (5) between each of the antennas (1). Support members (6) can be attached to the bent horizontal pipe (5) to aid in mounting on a structure. This creates effective isolation for multiple antenna configurations.

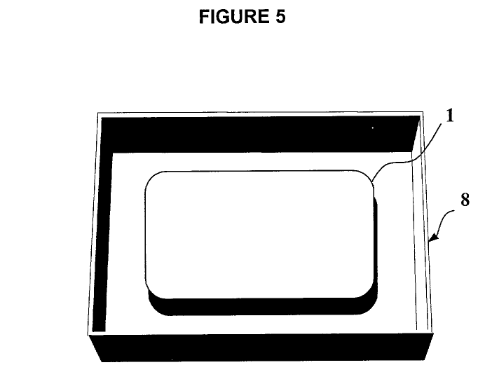

For tower, or other type vertical structure, the shielding means shown in FIG. 4 is highly effective. Appropriate mounting brackets (not shown) would be attached to the backs of the antennas (1) and also to the shield (4). The shield is constructed by welding a u-bolt or other appropriate mounting bracket (not shown) to a 0.40 mild steel sheet. When used with the Breezcom antennas described earlier, the shield (4) should protrude approximately 12 inches from the tower (7) and be approximately 18 inches wide. The antennas (1) should have approximately 24 inches between them with the shield (4) being placed equidistant between the antennas (1) or approximately 12 inches from the shield (4).

For complete isolation, the most effective means of shielding is the box style shielding device shown in FIG. 5. The antenna (1) is basically placed inside a steel box made of 0.40 mild steel and open at the aperture end creating a box shield (8). At least a 5-inch gap should be maintained from the edge of the antenna (1) to the box shield (8) sidewall. For best results, the box shield (8) can protrude approximately 4 inches from the antenna (1) front. Multiple “box” shielded antennas can be mounted beside, behind, beneath and above other similarly shielded antennas with little concern of self-interference.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and other embodiments are intended to be included within the scope of the claims.

What is claimed is:

1. An antenna shielding method and system that eliminates unwanted interference between collocated antennas being used in a high speed wireless system comprising:
a first antenna;
a second antenna;
said first antenna collocated with said second antenna such that the aperture of said first antenna faces in the generally opposite direction as the aperture of said second antenna;
a sheet of shielding material having a perimeter greater than the perimeter of the aperture of said first antenna;
said sheet of shielding material being placed behind said first antenna; and,
said first antenna being collocated behind said second antenna such that said sheet of shielding material is sandwiched between said first and second antennas.

2. An antenna shielding method and system according to claim 1 wherein said sheet of shielding material is constructed of mild steel.

3. An antenna shielding method and system that eliminates unwanted interference between collocated antennas being used in a high speed wireless system comprising:
two or more antennas placed adjacent to one another in a generally horizontal configuration resulting in at least one adjacent antenna pair;
one or more sheets of shielding material; and,
said one or more sheets of shielding material being placed in a generally perpendicular plane intersecting a line between the apertures of each said adjacent antenna pair.

4. An antenna shielding method and system according to claim 3 wherein said one or more sheets of shielding material is constructed of mild steel.

5. An antenna shielding method and system according to claim 4 wherein said one or more sheets of shielding material extends beyond the front of the apertures of said adjacent antenna pair by at least approximately four inches.

6. An antenna shielding method and system according to claim 5 wherein each of said one or more sheets of shielding material is placed between the apertures of each said adjacent antenna pair such that each of said one or more sheets of shielding material is not closer than at least approximately five inches to the apertures of said adjacent antenna pair.

7. An antenna shielding method and system according to claim 3 wherein said two or more horizontally placed antennas are placed in a generally curved horizontal configuration.

8. An antenna shielding method and system according to claim 7 wherein said one or more sheets of shielding material is constructed of mild steel.

9. An antenna shielding method and system according to claim 8 wherein said one or more sheets of shielding material extends beyond the front of the apertures of said adjacent antenna pair by at least approximately four inches.

10. An antenna shielding method and system according to claim 9 wherein each of said one or more sheets of shielding material is placed between the apertures of each said adjacent antenna pair such that each of said one or more sheets of shielding material is not closer than at least approximately five inches to the apertures of said adjacent antenna pair.

11. An antenna shielding method and system that eliminates unwanted interference between collocated antennas being used in a high speed wireless system comprising:
two or more antennas mounted adjacent to one another in a generally vertical configuration resulting in at least one adjacent antenna pair;
one or more sheets of shielding material; and
said one or more sheets of shielding material being placed in a generally perpendicular plane intersecting a line between the apertures of each said adjacent antenna pair.

12. An antenna shielding method and system according to claim 11 wherein said one or more sheets of shielding material is constructed of mild steel.

13. An antenna shielding method and system according to claim 12 wherein said one or more sheets of shielding material extends beyond the front of the apertures of said adjacent antenna pair by at least approximately four inches.

14. An antenna shielding method and system according to claim 13 wherein each of said one or more sheets of shielding material is placed between the apertures of each said adjacent antenna pair such that each of said one or more sheets of shielding material is not closer than at least approximately five inches to the apertures of said adjacent antenna pair.

15. An antenna shielding method and system that eliminates unwanted interference between collocated antennas being used in a high speed wireless system comprising:
two or more collocated antennas; and
each antenna of said two or more collocated antennas being enclosed in a shielding material box having side walls and a back wall and one open side corresponding to the aperture of said each antenna.

16. An antenna shielding method and system according to claim 15 wherein said shielding material box is constructed of mild steel.

17. An antenna shielding method and system according to claim 16 wherein said each antenna is placed inside said shielding material box such that at least approximately a five inch gap is maintained from the aperture of said each antenna to said side walls of said shielding material box.

18. An antenna shielding method and system according to claim 17 wherein said each antenna is placed inside said shielding material box such that said one open side of said shielding material box is at least approximately four inches in front of the aperture of said each antenna placed within said shielding material box.
